(19) United States
(12) Patent Application Publication
(10) Pub. No.: US 2008/0148614 A1
(43) Pub. Date: Jun. 26, 2008

(54) Placard holder and retaining device

(75) Inventor: Donald George Costar, Reno, NV (US)

Correspondence Address: Donald G. Costar, 1560 Hillside Drive, Reno, NV, 89503-1713, US

(73) Assignee: Donald George Costar, Reno, NV (US)

(21) Appl. No.: 11/644,736

(22) Filed: Dec. 22, 2006

(51) Int. Cl. G09F 15/00

(52) U.S. Cl. 40/606.15

(57) ABSTRACT

A placard holder configured through a connecting means to loosely but securely engage a vehicular rear view mirror support arm, thereby allowing said placard holder to be rotated upwards and above said rear view mirror support arm. An engaging device, may then be utilized so as to retain and hold the placard holder until released and allowed to rotate back into a proper position for display.

### CROSS REFERENCE TO RELATED APPLICATIONS

Not applicable

### FEDERALLY SPONSORED RESEARCH

Not applicable

### SEQUENCE LISTING OR PROGRAM

Not applicable

### FIELD OF THE INVENTION

The present invention generally relates to special parking privilege licenses in the form of placards displayed in vehicles, and more specifically relates to placard holders and a means for stowing said holders while not in use.

### BACKGROUND OF THE INVENTION—PRIOR ART

Previously, documents created to bestow upon vehicles special parking or entry privileges were affixed to bumpers or windshields. Some were in the form of placards placed on the dashboard for visibility through the windshield.

Documents pertaining only to the vehicle itself are presently still affixed to vehicles, but documents pertaining to the driver or passenger needed to be more portable. Hence a more efficient method of displaying authorization documents were developed into those hung from rear view mirror supports in the form of special placards. This evolved method, still in use today, is convenient, portable and visible.

Unfortunately a placard hung from a rear view mirror presents a visual hazard for drivers by creating a blind spot where pedestrians or other vehicles may be temporarily hidden from the driver's field of sight. Recognizing this, State Motor Vehicle laws prohibit hanging placards from a rear view mirror while operating the vehicle. In order to comply, drivers must remove the placard from the rear view mirror support before operating the vehicle. In doing so the placard must be stowed somewhere temporarily, subjecting the placard to possible loss, damage, or misplacement.

Some attempts to improve the situation have been made, such as in U.S. Pat. No. 6,708,435 to Massey, Mar. 23, 2004, which offers portability and protection from damage, but still must be stowed somewhere while operating the vehicle. U.S. Pat. No. 6,276,081 to Shedd, Aug. 21, 2001, which offers a means for stowing the placard temporarily if the placard is attached to a rather complex, pivoting device that in turn is attached to a sun visor. Shedd's patent offers temporary storage for the placard, but little protection against damage and is not easily transported from vehicle to vehicle. U.S. Pat. No. D.429,286 to Luciani, Aug. 8, 2000, offers protection and portability for the placard, but still must be stowed somewhere while operating the vehicle.

### SUMMARY OF THE INVENTION

It is the primary objective of the present invention to provide a simple placard stowing apparatus that utilizes the rarely used space above a rear view mirror of a motor vehicle and is easily transported from vehicle to vehicle.

The apparatus comprises a placard holder configured to engage a rear view mirror support arm. The placard holder itself should preferably be configured such that a front portion and a rear portion of clear or transparent flexible plastic are affixed and sealed on three sides but open at a top end of the front portion, so that a placard inserted into said placard holder may partially protrude from said open end of said front portion. The rear portion of the placard holder should preferably be longer than the front portion, and should be configured so as to include an attached releasable claw or hook means to loosely, but securely, engage the rear view mirror support arm, thereby allowing said placard holder to be rotated up and above the rear view mirror support arm where it may be temporarily secured by an engaging and holding device, preferably a hook and loop type, with one portion preferably affixed to the rear surface portion of said placard holder, and an opposing member of the hook and loop apparatus preferably affixed to the top surface of the rear view mirror.

The hook and loop device opposing portions may then be engaged so as to retain and hold the placard holder at the juncture of the top surface of the rear view mirror and the rear portion of the placard holder, above and out of the sight pattern of the driver of the vehicle. Said placard holder would thusly be retained above the rear view mirror until released and allowed to rotate back into a proper position for displaying the placard while parked.

### OBJECTS AND ADVANTAGES

Accordingly, several objects and advantages of the present invention are:
(a) to provide an inexpensive placard holder and retaining device, using attaching devices and parts already in mass production;
(b) to utilize a space rarely used in automobiles to perform an important function, i.e. To stow a placard above the rear view mirror;
(c) to help avoid traffic law violations due to operating a vehicle with a placard hanging from a rear view mirror, or when parking in a space designated for special use, because the driver lost or misplaced the appropriate placard;
(d) to provide for identification of the owner of the special privilege placard while traveling or transporting the placard holder from one vehicle to another.

Still further objects and advantages will become apparent from consideration of the ensuing description and drawings.

### DRAWINGS—FIGURES

FIG. 1 Is a perspective view the placard holder showing the preferable configuration of a typical releasable claw or hook device that attaches to a rear view mirror support arm.

FIG. 2 Is a side cross section view of a preferred embodiment of the present invention hanging; showing a front portion, a longer rear portion, the placement of a typical placard and releasable claw or hook device.

FIG. 3 Is a front elevation view of a preferred embodiment of the present invention, showing a front portion, a longer rear portion, both portions bonded and sealed at three sides and leaving the top edge of the front portion open to receive a typical placard for display through the windshield.

FIG. 4 Is a rear elevation view of an embodiment of the present invention showing a typical location of a portion of the hook and loop device attached to the placard holder rear surface.

FIG. 5 Is a front elevation, or face on, view of a typical rear view mirror of a motor vehicle, showing an end view cross section of the placard holder stowed and retained in a holding position while a driver is operating the vehicle.

FIG. 6 Is a side view cross section of a typical rear view mirror of a motor vehicle, illustrating the location of the present invention temporarily stowed in holding position while a driver is operating the vehicle.

### DETAILED DESCRIPTION OF THE INVENTION

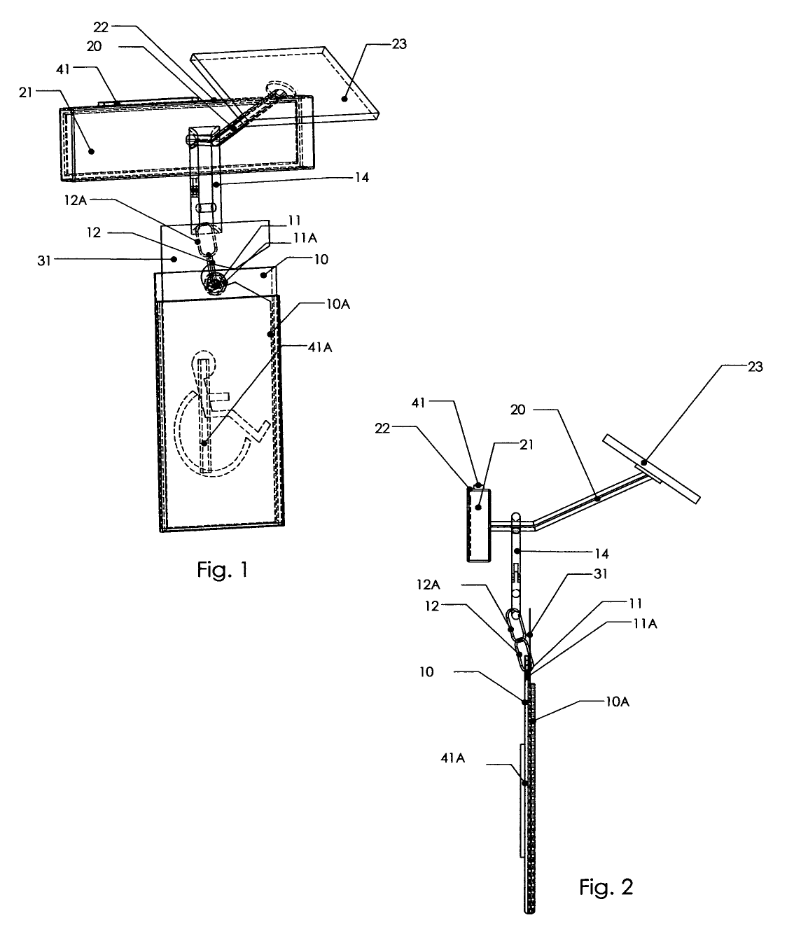

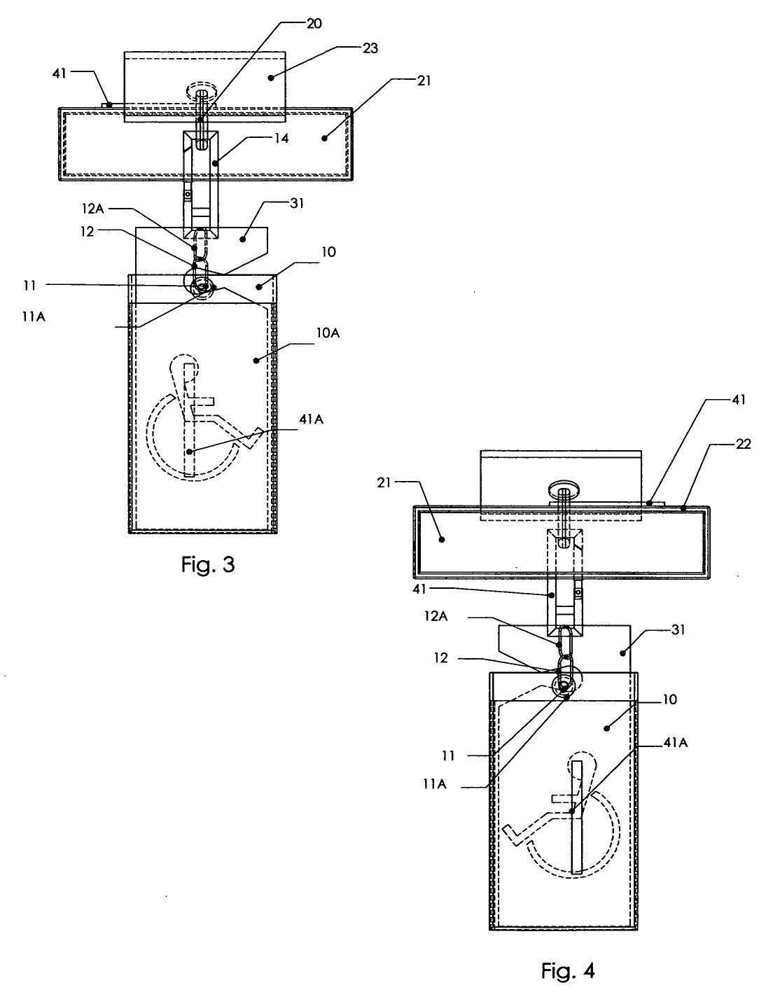

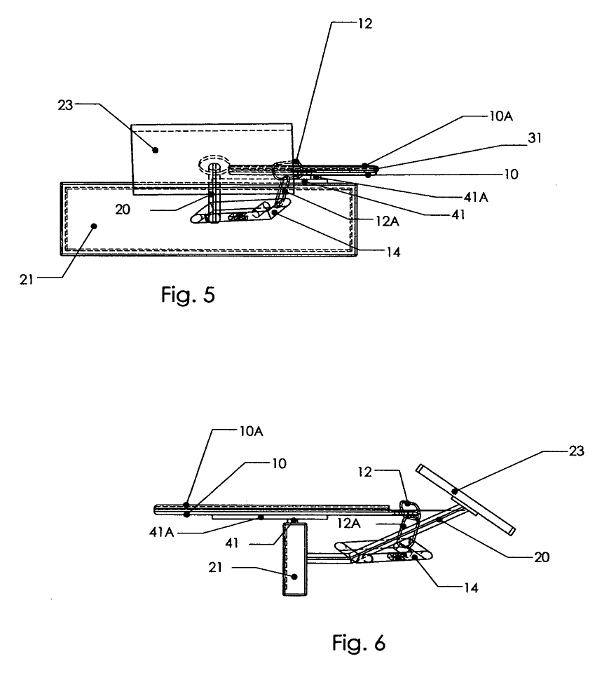

Referring now to the drawings, and more specifically to FIG. 1, the present invention comprises a placard holder rear portion 10 which exceeds the front portion 10a in length so as to form an open ended pocket, or front portion 10a, in order to receive a typical placard 31.

In a preferred embodiment, the placard holder will be flat and generally rectilinear. In the preferred embodiment shown in FIG. 1, the rear portion 10 will contain a hole 11 which may or may not be reinforced with a grommet 11a and include an attaching ring, or link 12 which in turn may link to an additional attaching ring, or link 12a if necessary. Said ring, rings, or links may in turn be connected to a typical releasable claw or clasping device 14.

FIG. 2 illustrates how the present invention will hang from a typical rear view mirror 21 support arm 20 previously attached to a motor vehicle windshield 23 when the present invention is in a proper display mode during the time the vehicle is parked. When the vehicle is being operated in traffic however, and if it is mandatory that the placard 31 be removed from the field of vision of the driver, then the present invention may be easily rotated up and above the rear view mirror support arm 20 to rest on the rear view mirror top surface 22 where a portion of a hook and loop attaching device 41 shown in FIG. 4 will become attached temporarily to the opposing portion of the hook and loop device 41a and be retained until released by the driver to allow it to rotate back down to its proper position for display when the vehicle is again parked.

While the present invention has been described with respect to what is presently considered to be the preferred embodiments, it is understood that the invention is not limited to the disclosed embodiments. The present invention is intended to cover the various modifications and arrangements that may arise within the scope and spirit of the attended claims.

What is claimed is:

1. A retaining device for temporarily stowing a placard, comprising:
(a) a placard holder configured to engage a vehicular rear view mirror support arm loosely, but securely, thereby allowing said placard holder to be rotated upwards and above said rear view mirror support arm,
(b) an engaging and holding device affixed to a surface above said rear view mirror support arm, whereby
(c) said device may then engage and retain said placard holder until released and allowed to rotate back into a proper position for display.

2. The placard holder of claim 1, wherein said placard holder may be constructed of a pliable and transparent material such as plastic.

3. The placard holder configuration of claim 1, wherein said means for engaging the rear view mirror support arm may be a releasable grasping claw or clasp device.

4. The retaining device of claim 1, wherein said engaging and holding apparatus may be of a two part hook and loop type fastener.

5. The retaining device of claim 1, wherein said engaging and holding apparatus may be a spring clip or the like.

6. The retaining device of claim 1, wherein said engaging and holding apparatus may be a magnetic clasp or the like.
